(19) United States
(12) Patent Application Publication
(10) Pub. No.: US 2023/0370404 A1
(43) Pub. Date: Nov. 16, 2023

(54) METHOD AND APPARATUS FOR MESSAGING SERVICE

(71) Applicant: KAKAO CORP., Jeju-si (KR)

(72) Inventors: Eun Hye KIM, Seongnam-si (KR); Han Wool CHA, Seongnam-si (KR); Seok Gyu LEE, Seongnam-si (KR); Sul Gi KIM, Seongnam-si (KR); In Hae CHOI, Seongnam-si (KR)

(21) Appl. No.: 18/318,629

(22) Filed: May 16, 2023

(30) Foreign Application Priority Data
May 16, 2022 (KR) 10-2022-0059846

(51) Int. Cl. H04L 51/046; G06Q 10/1093

(52) U.S. Cl. CPC H04L 51/046; G06Q 10/1095

(57) ABSTRACT

A method and apparatus for a messaging service are provided. An operating method of a server providing an assistant function linked with an application for a messaging service includes monitoring an execution of the application of a terminal logging in with a user account subscribing to the messaging service, determining whether a briefing execution condition for the assistant function is satisfied based on a result of the monitoring, identifying briefing targets from records generated based on an execution of the assistant function of the terminal based on a result of the determining, and transmitting a briefing message to notify the number of the identified briefing targets to the terminal.

### CROSS-REFERENCE TO RELATED APPLICATION(S)

This application claims the priority benefit of Korean Patent Application No. 10-2022-0059846 filed on May 16, 2022, in the Korean Intellectual Property Office, the disclosure of which is incorporated herein by reference for all purposes.

### BACKGROUND

### Technical Field

One or more embodiments relate to a method and apparatus for a messaging service. More specifically, the embodiments relate to a terminal on which an application for the messaging service is installed and a server providing an assistant function linked with the application for the messaging service.

### Description of the Related Art

Recently, with the development of mobile smart devices, the use of an online platform service to communicate with other users via network has increased. The online platform services for interaction with other users may include, as representative examples, a social networking service (SNS), which is an online platform for generating and consolidating social relationships through communication among users, information sharing, and expansion of personal connections, and an instant messaging service (IMS), which is an online platform for real-time content communication between two or more users.

The increase in communication via mobile devices has further allowed the online platform services to support functions for sharing various types of data and assisting communication in addition to a function for users to have one-on-one communication with other users by text.

### BRIEF SUMMARY

An aspect provides a messenger application configured to perform an assistant function to assist a user's life, such as the user's scheduling, besides a message transmission and reception function.

Another aspect also provides an assistant function notifying a user of a record generated by executing the assistant function in a message form when an application is executed.

However, technical aspects are not limited to the foregoing aspects, and there may be other technical aspects.

According to an aspect, an operating method of a server providing an assistant function linked with an application for a messaging service includes monitoring an execution of the application of a terminal logging in with a user account subscribing to the messaging service; determining whether a briefing execution condition for the assistant function is satisfied based on a result of the monitoring; identifying briefing targets from records generated based on an execution of the assistant function of the terminal based on a result of the determining; and transmitting a briefing message to notify the number of the identified briefing targets to the terminal.

The determining whether the briefing execution condition is satisfied may include determining whether the execution of the application is a first execution corresponding to the user account within a predetermined period.

The determining whether the briefing execution condition is satisfied may further include verifying a reception setting of the user account for the briefing message based on the monitoring result.

The verifying the reception setting may include at least one of verifying whether reception of the briefing message is allowed and verifying whether a reception time of the briefing message is limited.

The identifying the briefing target may include identifying the briefing target based on time information comprised by the record and a time of the briefing message transmitted.

The identifying the briefing target may further include identifying the briefing target by each type of the record determined based on the executed assistant function.

The assistant function may include at least one of a scheduling function, a to-do management function, and a reserved message management function, and the record may include a first-type record on a schedule generated based on an execution of the scheduling function; a second-type record on a to-do generated based on an execution of the to-do management function; and a third-type record on a reserved message generated based on an execution of the reserved message management function.

The briefing message may be transmitted through at least one of a first-type chatroom not including another user account and a second-type chatroom including an official account for the assistant function.

The transmitting the briefing message to the terminal may include generating information on the number of the identified briefing targets as data in a format to be transmitted as a message and requesting a messaging server to transmit the briefing message based on the generated data.

According to another aspect, an operating method of a terminal on which an application for a messaging service is installed includes receiving a briefing message from a server providing an assistant function linked with the application based on an execution of the application; receiving an input of calling the assistant function through the received briefing message; and displaying an assistant interface including a record registered corresponding to the called assistant function.

The briefing message may include information on the number of records corresponding to a specific period among records registered corresponding to the assistant function.

The receiving the briefing message may include receiving the briefing message through at least one of a first-type chatroom not including another user account and a second-type chatroom including an official account for the assistant function.

The assistant function may include at least one of a scheduling function, a to-do management function, and a reserved message management function, and the record may include a first-type record on a schedule generated based on an execution of the scheduling function; a second-type record on a to-do generated based on an execution of the to-do management function; and a third-type record on a reserved message generated based on an execution of the reserved message management function.

The operating method of the terminal may further include setting a reception condition for the briefing message.

The reception condition may include whether reception of the briefing message is allowed and time information when the reception of the briefing message is allowed.

The operating method of the terminal may further include requesting registration of a new record corresponding to the assistant function based on a record input received through the assistant interface.

According to another aspect, a server providing an assistant function linked with an application for a messaging service includes at least one processor configured to monitor an execution of the application of a terminal logging in with a user account subscribing to the messaging service, determine whether a briefing execution condition for the assistant function is satisfied based on a result of the monitoring, identify briefing targets from records generated based on an execution of the assistant function of the terminal based on a result of the determining, and transmit a briefing message to notify the number of the identified briefing targets to the terminal.

The processor is further configured to, when determining whether the briefing execution condition is satisfied, determine whether the execution of the application is a first execution corresponding to the user account within a predetermined period.

According to another aspect, a terminal on which an application for a messaging service is installed includes at least one processor configured to receive a briefing message from a server providing an assistant function linked with the application based on an execution of the application, receive an input of calling the assistant function through the received briefing message, and display an assistant interface including a record registered corresponding to the called assistant function.

Additional aspects of example embodiments will be set forth in part in the description which follows and, in part, will be apparent from the description, or may be learned by practice of the disclosure.

### BRIEF DESCRIPTION OF THE SEVERAL VIEWS OF THE DRAWINGS

These and/or other aspects, features, and advantages of the present disclosure will become apparent and more readily appreciated from the following description of example embodiments, taken in conjunction with the accompanying drawings of which:

FIG. 1 is a flowchart illustrating an operation of a server providing an assistant function linked with an application for a messaging service, according to an embodiment;

FIG. 2 is a flowchart illustrating an operation of a terminal on which an application for a messaging service is installed, according to an embodiment;

FIG. 3 is a diagram illustrating an example of a screen of a chat interface displaying a briefing message transmitted to a terminal, according to an embodiment;

FIGS. 4A and 4B are diagrams illustrating a screen of a scheduling interface according to an embodiment;

FIGS. 5A and 5B are diagrams illustrating a screen of a to-do management interface according to an embodiment;

FIGS. 6A and 6B are diagrams illustrating a screen of a reserved message management interface according to an embodiment;

FIG. 7 is a diagram illustrating an example of a screen of an assistant interface provided through an application for a messaging service, according to an embodiment; and

FIG. 8 is a diagram illustrating an example of a screen of an interface for a reception setting for a briefing message, according to an embodiment.

### DETAILED DESCRIPTION

Terms, such as first, second, and the like, may be used herein to describe various components. Each of these terminologies is not used to define an essence, order or sequence of a corresponding component but used merely to distinguish the corresponding component from other component(s). For example, a first component may be referred to as a second component, and similarly the second component may also be referred to as the first component.

It should be noted that if it is described that one component is “connected,” “coupled,” or “joined” to another component, a third component may be “connected,” “coupled,” and “joined” between the first and second components, although the first component may be directly connected, coupled, or joined to the second component.

The singular forms “a,” “an,” and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Hereinafter, embodiments will be described in detail with reference to the accompanying drawings. When describing the embodiments with reference to the accompanying drawings, like reference numerals refer to like elements and a repeated description related thereto will be omitted.

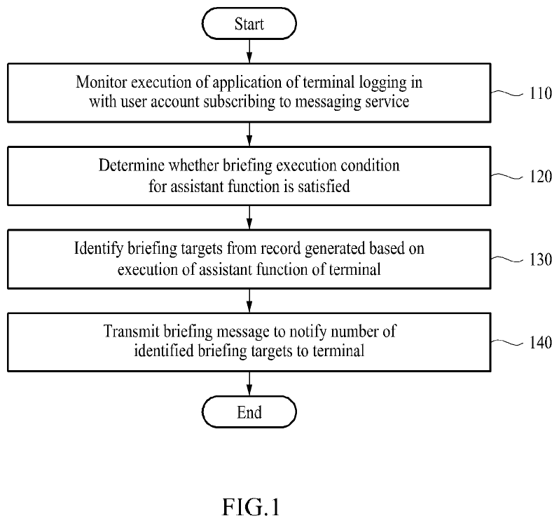

FIG. 1 is a flowchart illustrating an operation of a server providing an assistant function linked with an application for a messaging service, according to an embodiment.

Referring to FIG. 1, an operating method of the server providing the assistant function linked with the application for the messaging service may include operation 110 of monitoring the execution of the application of a terminal logging in with a user account subscribing to the messaging service, operation 120 of determining whether a briefing execution condition for the assistant function is satisfied based on a result of the monitoring, operation 130 of identifying briefing targets from records generated based on the execution of the assistant function of the terminal based on a result of the determining, and operation 140 of transmitting a briefing message to notify the number of the identified briefing targets to the terminal.

According to an embodiment, the server may provide a service for the assistant function linked with the application for the messaging service. The messaging service may be a service for receiving and transmitting messages between users subscribing to the application or for transmitting a notification message to a subscribing user and may include, for example, an instant messaging service based on an instant message. The application for the messaging service may include a messenger application installed on the terminal of the subscribing user.

According to an embodiment, the messaging server may generate a user account for the messaging service in response to a messaging service subscription request from a user. The user account may be a unit for identifying, by the server, a user subscribing to a service. The terminal logging in with the user account may use the service provided by the server. Hereinafter, the terminal may be the terminal logging in with the user account generated by subscribing to the service.

According to an embodiment, the messaging service may be provided to the terminal through a chat interface. The chat interface may be an interface for a message transmission/reception function provided by the messaging service and may include, for example, an interface that provides a function of transmitting messages through a chatroom, in which at least one user account participates, and displaying received messages. The chat interface may correspond to a chatroom, which is a virtual space in which at least one user account participates and a chat between users takes place.

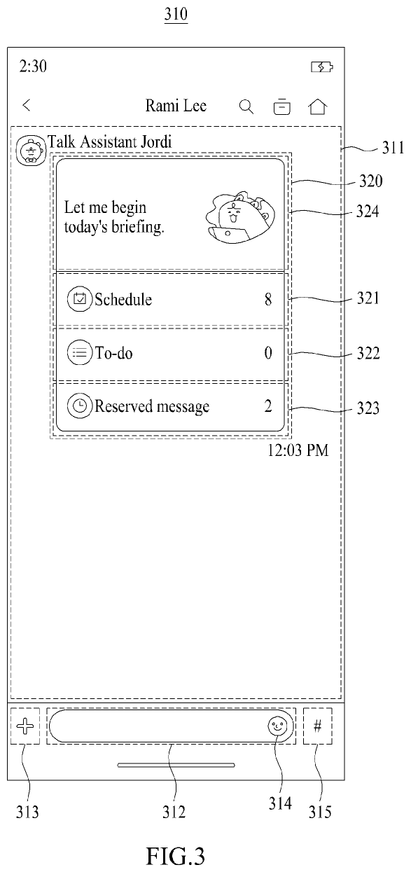

For example, the chat interface may include an interfacing object that supports a function of transmitting and receiving messages through a chatroom. The interfacing object may be an object implemented to perform a predetermined function through interaction with a user and may include, for example, a button, an input field, a switch, and other objects. An example of the chat interface may be a screen 310 illustrated in FIG. 3. For example, referring to FIG. 3, the chat interface may include an interfacing object supporting a function related to the messaging service, such as a chat window 311 displaying a message transmitted and received through a chatroom, an input window 312 for inputting text to be transmitted as a message, and/or buttons 313, 314, and 315 for requesting the server for a predetermined function or service.

According to an embodiment, the assistant function may be a function that is provided to enhance the convenience of a user, besides a function of transmitting and receiving a message in the application for the messaging service and may include at least one of, for example, a search function through a chatroom, a scheduling function, a to-do management function, and a reserved message management function. The assistant function is described in detail below.

According to an embodiment, the assistant function may be provided by a messaging server or a separate server linked with the messaging server. For example, different servers may provide different assistant functions. In other words, a server providing the assistant function linked with the application for the messaging service may be the messaging server or the separate server that is linked with the messaging server and implemented to provide the assistant function through the application for the messaging service. Hereinafter, the server providing the assistant function linked with the application for the messaging service may be simply referred to as the “server”.

According to an embodiment, the server may monitor the execution of the application of the terminal logging in with the user account subscribing to the messaging service in operation 110. The monitoring of the execution of the application may be detecting the execution of the application. For example, when the application is executed in the terminal logging in with the user account, the server may receive a signal indicating the user account accesses the application from the terminal. Based on the received signal, the server may detect the execution of the application corresponding to the user account. According to an embodiment, based on the signal indicating the user account accesses the application, the server may manage the access information of the user account.

According to an embodiment, based on a monitoring result, the server may determine whether the briefing execution condition for the assistant function is satisfied in operation 120. The briefing execution condition for the assistant function may be a condition to determine whether to transmit a briefing message for a record generated based on the execution of the assistant function and may include, for example, a condition for whether the execution of the application is the first execution corresponding to the user account within a predetermined period and/or a condition for a reception setting of the user account for the briefing message. For example, the briefing execution condition may be a condition to perform operations 130 and 140 for transmitting the briefing message described in detail below. In other words, when the briefing execution condition is satisfied, the server may perform operations 130 and 140 for transmitting the briefing message.

According to an embodiment, operation 120 may include an operation of determining whether the execution of the application is the first execution corresponding to the user account within the predetermined period. For example, the predetermined period may include a day, a week, a time from 12 AM to 11 PM, and other periods. Whether to be the first execution may be determined based on the access information of the user account logging in to the terminal executing the application. For example, when the execution of the application of the terminal logging in with a first user account is detected, the server may verify whether there is a record of the first user account having accessed the application within the predetermined period. When there is no record of the first user account having accessed the application within the predetermined period, the detected execution of the application may be the first execution corresponding to the first user account. When the execution of the application is the first execution corresponding to the user account within the predetermined period, the server may determine that the briefing execution condition is satisfied. For example, under the assumption that the predetermined period is one day, when the user account is determined to access the application for the first time during the day, the server may determine that the briefing execution condition is satisfied.

According to an embodiment, operation 120 may include an operation of verifying the reception setting of the user account for the briefing message based on the monitoring result.

According to an embodiment, the verifying of the reception setting of the user account may include at least one of an operation of verifying whether the reception of the briefing message is allowed or an operation of verifying whether a reception time of the briefing message is limited. For example, after verifying the reception setting of the user account, when the reception of the briefing message is set to be allowed, the server may determine that the briefing execution condition is satisfied. As another example, after verifying the reception setting, when a restriction on the reception time of the briefing message is set, the server may determine that the briefing execution condition is satisfied at a set time when the reception of the briefing message is allowed. In addition, when the reception of the briefing message is set to be not allowed, the server may determine that the briefing execution condition is not satisfied.

According to an embodiment, the briefing execution condition may include a plurality of conditions. When all the conditions are determined to be satisfied, the server may determine that the briefing execution condition is satisfied. For example, when the briefing execution condition includes a condition for whether the execution of the application is the first execution corresponding to the user account within the predetermined period and a condition for the reception setting of the user account for the briefing message, and when the execution of the application is the first execution corresponding to the user account within the predetermined period, and the setting of allowing the reception of the briefing message is verified, the briefing execution condition may be determined to be satisfied.

According to an embodiment, based on the determination result of whether the briefing execution condition is satisfied, the server may identify a briefing target from the records generated based on the execution of the assistant function of the terminal in operation 130. For example, when the briefing execution condition is determined to be satisfied in operation 120, the server may perform operation 130 of identifying the briefing target.

According to an embodiment, the briefing target may be a record satisfying a briefing condition among the records generated based on the execution of the assistant function of the terminal. The identifying of the briefing target may be detecting the record satisfying the briefing condition from among the records generated based on the execution of the assistant function. A record may be a unit of data generated based on the execution of the assistant function and may include at least one of, for example, a first-type record on a schedule generated based on the execution of the scheduling function, a second-type record on a to-do generated based on the execution of the to-do management function, and a third-type record on a reserved message generated based on the execution of the reserved message management function. The records generated based on the execution of the assistant function of the terminal may be stored corresponding to the user account logging in to the terminal.

For example, the terminal, by executing the scheduling function provided through the application, may request the server to generate a schedule. The server may generate the first-type record on the schedule based on a schedule generation request including information on a new schedule. For example, the first-type record may include information on a schedule, such as a name of the schedule and a time of the schedule. The generated records may be stored corresponding to the user account logging in to the terminal.

According to an embodiment, the briefing condition may be a condition to identify a record providing information through the briefing message from among the records stored corresponding to the user account. For example, the briefing condition may include a condition for time information included by the record. According to an embodiment, operation 130 of identifying the briefing targets may include identifying the briefing targets based on the time information included by the record and an execution time of the application. For example, the first-type record may include the time information on a start time of the schedule and an end time of the schedule. The second-type record may include the time information on a due date of the to-do. The third-type record may include the time information on a transmission time of the reserved message.

According to an embodiment, the server may determine whether the time information of the record corresponds to a period corresponding to the execution time of the application. For example, the briefing target may be a record corresponding to a date to which a time of transmitting the briefing message belongs among the records stored corresponding to the user account.

For example, when a date to which the time of executing the application belongs is the same as or after a date to which the start time of the first-type record belongs or the same as or before a date to which the end time of the first-type record belongs, the first-type record may be identified to be the briefing target. For example, when the date to which the time of executing the application belongs is the same as or before the date to which the end time of the first-type record belongs, the first-type record may be identified to be the briefing target. For example, when the date to which the time of executing the application belongs is before the due date of the to-do included by the second-type record, the second-type record may be identified to be the briefing target. For example, when the date to which the time of executing the application belongs is a date corresponding to the time of transmitting the reserved message included by the third-type record, the third-type record may be identified to be the briefing target.

For example, the briefing condition may include a condition related to a completion state included by the record. For example, a record corresponding to an incomplete state among the records may be identified to be the briefing target. For example, the first-type record may include a parameter indicating whether the schedule is completed and may be identified to be the briefing target when the parameter is set to be a value indicating an incomplete state. The second-type record may include a parameter indicating whether the to-do is completed and may be identified to be the briefing target when the parameter is set to be a value indicating an incomplete state. The third-type record may include a parameter indicating whether the transmission of the reserved message is completed and may be identified to be the briefing target when the parameter is set to be a value indicating an incomplete state.

According to an embodiment, operation 130 of identifying the briefing targets may include identifying the briefing targets by the types of records determined based on the executed assistant function. The identified briefing targets may be divided by the types of records. For example, the briefing targets may be divided into the first-type record, the second-type record, and the third-type record.

According to an embodiment, the server may transmit the briefing message to notify the number of the identified briefing targets to the terminal in operation 140. The briefing message may include the number of the briefing targets by their types. In other words, the briefing message may include a message indicating the number of the briefing targets identified by the types of the records. For example, the briefing message may include a message indicating that the number of briefing targets corresponding to the first-type record is x, the number of briefing targets corresponding to the second-type record is y, and the number of briefing targets corresponding to the third-type record is z. For example, when there is no briefing target corresponding to a type of a record, the number of briefing targets corresponding to the type may be displayed as 0, or information on the record of the type may be omitted from the message.

According to an embodiment, the briefing message may further include information on the briefing targets, besides the number of the briefing targets. For example, the briefing message may include, by items of the record identified to be the briefing target, information (e.g., the name of the schedule, the time information of the schedule, a place of the schedule, and/or an invitee of the schedule) on the schedule included by the first-type record, information (e.g., a name of the to-do, due date information of the to-do, and/or information on whether the to-do is completed) on the to-do included by the second-type record, and information (e.g., content of the reserved message, an expected transmission time of the reserved message, a transmission target of the reserved message, and/or information on whether a reminder of the reserved message is set) on the reserved message included by the third-type record.

According to an embodiment, the briefing message may include a separate list including a record set to be an important record by a user among the briefing targets or obtainable additional information (e.g., weather information when the briefing targets are the first-type record) corresponding to the briefing targets.

A specific example of a briefing message according to an embodiment is described in detail below.

According to an embodiment, the briefing message may be transmitted through a predetermined type of a chatroom. The type of the chatroom may be determined based on at least one of the number of user accounts included by the chatroom and a method of participating in the chatroom. For example, the type of the chatroom may include a chatroom with yourself that does not include another user account, a 1:1 chatroom that includes another user account, and a group chatroom that includes two or more other user accounts. As another example, the type of the chatroom may include a general chatroom and an anonymous chatroom. The general chatroom may be a chatroom generated by designating other user account(s), of which account information is registered in the messenger application, as a participant of the chatroom. A user of the messenger application may register identification information on a user account, such as a phone number and an identification (ID), as a user account in a friend relationship. The general chatroom may be a chatroom including other user account(s), of which the account information is registered in the messenger application, or registered as a friend, as a participant. The anonymous chatroom may be a chatroom in which user account(s) may participate through link information regardless of being a friend or not in the messenger application. For example, an anonymous chatroom service may include an open chat service (a registered trademark of Kakao Corp.) provided by Kakao, that is, the applicant of the present disclosure, and more specifically, a non-acquaintance-based open chat service provided by a KakaoTalk application of the applicant of the present disclosure. The anonymous chatroom may be a chatroom of the open chat service provided by Kakao, that is, the applicant of the present disclosure. The open chat service provided by Kakao is an example of an anonymous chatroom service, and examples are not limited thereto. An anonymous chatroom service may include a service providing a chatroom in which a user participates by using a temporary profile, not a real-name-based account.

For example, the briefing message may be transmitted through a first-type chatroom (e.g., the chatroom with yourself), not including other user accounts. For example, the briefing message may be transmitted through the chatroom with yourself by using an official account for the assistant function as a sender. For example, the official account for the assistant function may be implemented as a chatbot.

As another example, the briefing message may be transmitted through a second-type chatroom including the official account for the assistant function. The chatroom including the official account for the assistant function may be a chatroom in which a notification message for the assistant function including the briefing message is transmitted. The notification message for the assistant function may be transmitted by using the official account for the assistant function as a sender.

According to an embodiment, when the server is a separate server different from the messaging server, the briefing message may be transmitted from the server to the terminal or through the messaging server. For example, operation 140 may include generating information on the number of the identified briefing targets as data in a format to be transmitted as a message and requesting the messaging server to transmit the briefing message based on the generated data. The messaging server may generate data on the number of briefing targets received from the server in a message form and transmit the generated data to the terminal.

According to an embodiment, at least one of operations 120 to 140 may be performed in the terminal on which the application for the messaging service is installed. For example, in response to the execution of the application for the messaging service, the terminal may perform at least one of operation 120 of determining whether the briefing execution condition for the assistant function is satisfied, operation 130 of identifying the briefing targets from the records generated based on the execution of the assistant function based on the determination result, and operation 140 of transmitting the briefing message to notify the number of the identified briefing targets.

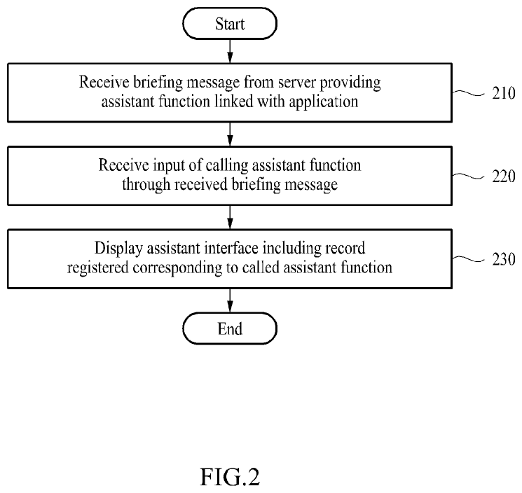

FIG. 2 is a flowchart illustrating an operation of a terminal on which an application for a messaging service is installed, according to an embodiment.

Referring to FIG. 2, an operating method of the terminal on which the application for the messaging service is installed may include operation 210 of receiving a briefing message from a server providing an assistant function linked with the application, operation 220 of receiving an input of calling the assistant function through the received briefing message, and operation 230 of displaying an assistant interface including a record registered corresponding to the called assistant function.

The terminal may be one of electronic apparatuses, such as a computer, a portable computer, a wireless phone, a mobile phone, a smartphone, a personalized digital assistant (PDA), a web tablet, and a wearable device, and may refer to any apparatus that may install and execute an application. The terminal may receive a service and/or content provided by a server under the control of the application. For example, under the control of the application, the terminal may perform overall service operations, such as service screen setting, data input, data transmission and reception, and data storage. For example, the terminal may process a user interface or user interaction through a processor and output a processing result through an output device of the terminal or transmit the processing result to a server.

According to an embodiment, an application installed on the terminal may include the application for the messaging service or a messenger application. The terminal may be provided with the messaging service according to the control of the messenger application and the assistant function provided by the server.

Based on the execution of the application, the terminal may receive the briefing message from the server providing the assistant function linked with the application in operation 210. As described above, the briefing message may include information on the number of records corresponding to a predetermined period (e.g., a day) among records registered corresponding to each of the assistant functions. For example, when the terminal logging in with a first user account does not execute the application within the predetermined period, the briefing message corresponding to the period may not be received. When the predetermined period is a day, and the terminal logging in with the first user account on a specific date does not access the application, the briefing message corresponding to the date may not be transmitted.

According to an embodiment, operation 210 of receiving the briefing message may include an operation of receiving the briefing message through a predetermined type of a chatroom. When the terminal accesses the predetermined type of the chatroom through the application, the briefing message transmitted to the terminal may be displayed on a chat interface corresponding to the chatroom. For example, the predetermined type of the chatroom may be a chatroom with yourself, and the briefing message may be transmitted by using an official account as a sender.

According to an embodiment, the terminal may receive an input of calling the assistant function through the received briefing message in operation 220. For example, in response to the call for the assistant function, the briefing message may be implemented as an interfacing object that operates to request the server to call the assistant function. For example, referring to FIG. 3, when an input of selecting a first interfacing object 321 indicating the number of first-type records included by a briefing message 320 is received, a scheduling function, that is, an assistant function corresponding to a first type, may be called. For example, when an input of selecting a second interfacing object 322 indicating the number of second-type records included by the briefing message 320 is received, a to-do management function, that is, an assistant function corresponding to a second type, may be called. For example, when an input of selecting a third interfacing object 323 indicating the number of third-type records included by the briefing message 320 is received, a reserved message management function, that is, an assistant function corresponding to a third type, may be called.

According to an embodiment, the terminal may display an assistant interface including the record registered corresponding to the called assistant function in operation 230. The assistant interface may be an interface to provide the called assistant function. For example, the assistant interface may include at least one of an interface to provide the scheduling function (hereinafter, the scheduling interface), an interface to provide the to-do management function (hereinafter, the to-do management interface), and an interface to provide the reserved message management function (hereinafter, the reserved message management interface). The assistant interface is described in detail below. An assistant function and an assistant interface according to an embodiment are described in detail below.

According to an embodiment, a user may retrieve a record registered corresponding to a user account through the assistant interface. For example, the scheduling interface may display a list of the first-type records registered by predetermined periods. For example, the to-do management interface may display a list of the second-type records registered by predetermined periods. For example, the reserved message management interface may display a list of the third-type records registered by predetermined periods. An assistant interface for retrieving registered records according to an embodiment is described in detail below.

According to an embodiment, the terminal may request the registration of a new record corresponding to the assistant function based on a record input received through the assistant interface. In other words, the assistant interface may provide a function of registering the new record, besides the retrieving of the registered records. An assistant interface for registering a new record according to an embodiment is described in detail below.

According to an embodiment, the terminal may set a reception condition for the briefing message. The reception condition may be a condition of determining whether the reception of the briefing message is limited and may include at least one of, for example, whether the reception of the briefing message is allowed and time information when the reception of the briefing message is allowed. The reception condition may be set corresponding to a user account logging in to the terminal.

Based on a setting input received through the application, the terminal may set whether to allow the reception of the briefing message corresponding to the logged-in user account. When the reception of the briefing message is set to be allowed, and the user executes the application for the first time within the predetermined period, the terminal may receive the briefing message. On the other hand, when the reception of the briefing message is set to be not allowed, the briefing message may not be transmitted to the terminal. When a time of allowing the reception of the briefing message is set, and a time of executing the application in the terminal belongs to the time of allowing the reception of the briefing message, the briefing message may be received.

According to an embodiment, the briefing message may be generated by the terminal and provided through the chat interface. In other words, the operating method of the terminal may include an operation of outputting the briefing message generated by the terminal through the chat interface, instead of operation 210 of receiving the briefing message from the server.

FIG. 3 is a diagram illustrating an example of a screen of a chat interface displaying a briefing message transmitted to a terminal, according to an embodiment.

Referring to FIG. 3, according to an embodiment, a briefing message 320 received from a server may be displayed on a chat window 311 of the chat interface that is output through the terminal. For example, the briefing message 320 may be transmitted through a chatroom with yourself by using an official account designated for an assistant function as a sender. The chat interface may correspond to the chatroom with yourself including messages received and transmitted through the chatroom with yourself. For example, the briefing message 320 may be implemented in a form of arranging at least one interfacing object for receiving a user input. Each interfacing object included by the briefing message 320 may include at least one of a visual indicator (e.g., an icon) representing an assistant function corresponding thereto, a name representing the assistant function, and information on the number of identified briefing targets.

For example, the briefing message 320 may include a first interfacing object 321, a second interfacing object 322, and a third interfacing object 323, in which the first interfacing object 321 indicates the number of first-type records identified as the briefing targets, the second interfacing object 322 indicates the number of second-type records identified as the briefing targets, and the third interfacing object 323 indicates the number of third-type records identified as the briefing targets.

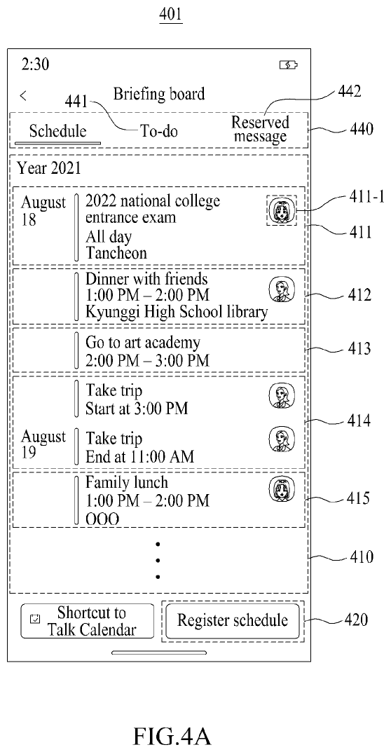

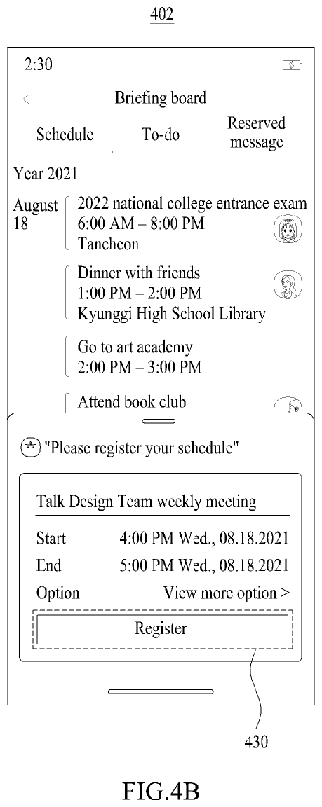

According to an embodiment, the first, second, and third interfacing objects 321, 322, and 323 may be implemented in a button for receiving an input of the user and calling the assistant functions. For example, when an input of selecting the first interfacing object 321 is received, a scheduling function may be called. The terminal may display a scheduling interface including the first-type records registered corresponding to the called scheduling function. A scheduling interface according to an embodiment is described in detail with reference to FIGS. 4A and 4B.

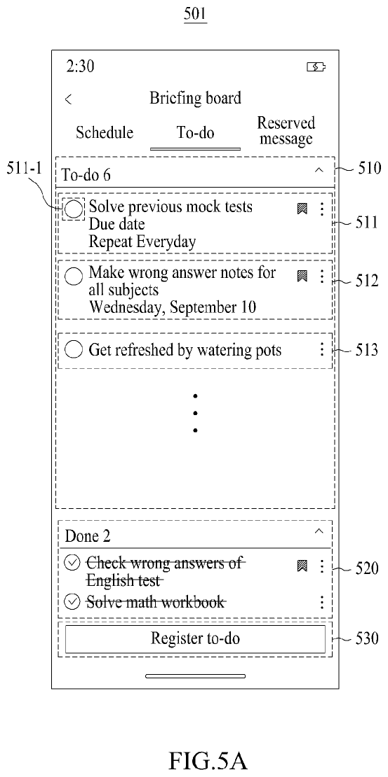

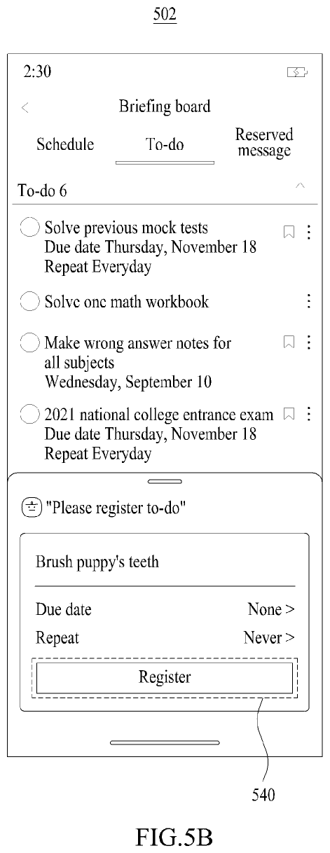

For example, when an input of selecting the second interfacing object 322 is received, a to-do management function may be called. The terminal may display a to-do management interface including the second-type records registered corresponding to the called to-do management function. A to-do management interface according to an embodiment is described in detail with reference to FIGS. 5A and 5B.

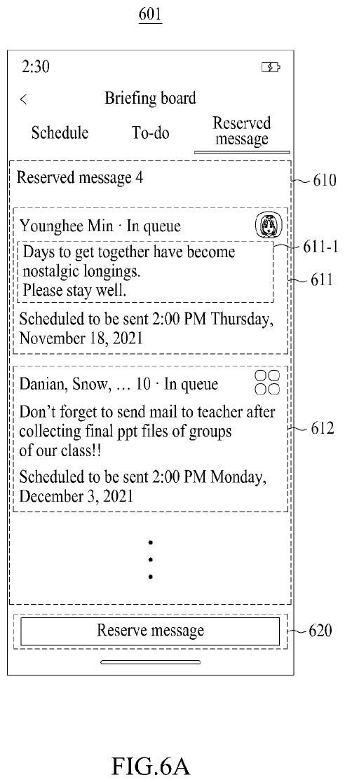

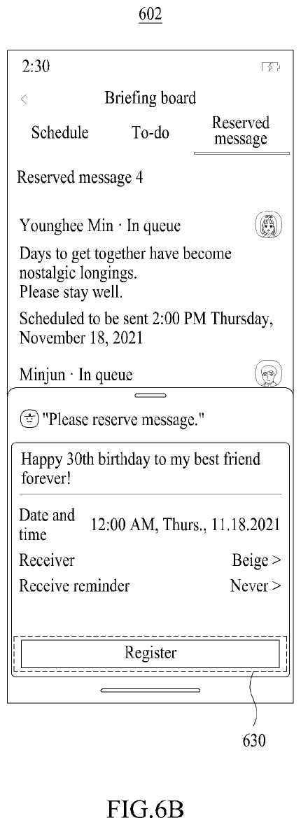

For example, when an input of selecting the third interfacing object 323 is received, a reserved message management function may be called. The terminal may display a reserved message management interface including the third-type records registered corresponding to the called reserved message management function. A reserved message management interface according to an embodiment is described in detail with reference to FIGS. 6A and 6B.

FIGS. 4A and 4B are diagrams illustrating a screen of a scheduling interface according to an embodiment.

For example, a screen 401 of the scheduling interface illustrated in FIG. 4A may be displayed on the terminal in response to a scheduling function called by an input of selecting the first interfacing object 321 included by the briefing message illustrated in FIG. 3.

Referring to FIG. 4A, the scheduling interface may include a list 410 of first-type records registered corresponding to a user account logging in to the terminal. For example, the list 410 of the first-type records may include a first-type record identified as a briefing target. The first-type record may be a data unit including information (e.g., a name of a schedule, time information of the schedule, a place of the schedule, and/or an invitation target of the schedule) on the schedule and may be referred to as the “schedule”.

For example, the scheduling interface may display the list 410 of schedules registered by dates. The list 410 of the schedules may include first, second, third, fourth, and fifth items 411, 412, 413, 414, and 415 of the schedules including information on the schedules. For example, the first item 411 included by the list 410 of the schedules may include the name (“2022 national college entrance exam”) of the schedule, the time information (“All day”) of the schedule, the place (“Tancheon”) of the schedule, and a profile photo 411-1 of the invitation target of the schedule. The time information of the schedule may be set to be a specific date (“All day”) as a whole, like the first item 411, and a start time (“1:00 PM”) and an end time (“2:00 PM”), like the second item 412. The start time of the schedule of which the time information is set to be ‘all day’ of the specific date may be 12:00 AM of the date, and the end time of the schedule may be 12:00 PM of the date.

According to an embodiment, some information of a schedule may not be input. For example, referring to the third item 413, the place of the schedule and the invitation target of the schedule may not be input.

According to an embodiment, a schedule corresponding to a specific date may be determined based on the time information of a set schedule. The schedule corresponding to the specific date may be identified as a briefing target of the date. For example, when the start time of a schedule and the end time of the schedule are on the same date, the schedule may be included in the schedule corresponding to the date to which the start time and the end time belong. In addition, when the start time of the schedule and the end time of the schedule are different dates, the schedule may be included in the schedules respectively corresponding to the respective dates to which the start time and the end time belong.

For example, the first, second, third, and fourth items 411, 412, 413, and 414 may be included in schedules corresponding to Aug. 18, 2022. The first, second, third, and fourth items 411, 412, 413, and 414 may be identified as a briefing target of Aug. 18, 2022. A briefing message transmitted on Aug. 18, 2022, may include a message indicating the number of the schedules corresponding to Aug. 18, 2022, is two. The fourth and fifth items 414 and 415 may be included in a schedule corresponding to Aug. 19, 2022. The fourth and fifth items 414 and 415 may be identified as a briefing target of Aug. 19, 2022. A briefing message transmitted on Aug. 19, 2022, may include a message indicating the number of the schedules corresponding to Aug. 18, 2022, is two.

For example, referring to the fourth item 414, the start time of a schedule and the end time of the schedule correspond to different dates, in which 3:00 PM, Aug. 18, 2022, is the start time, and 11:00 AM, Aug. 19, 2022, is the end time. The fourth item 414 may correspond to both Aug. 18 and 19, 2022. In other words, the fourth item 414 may correspond to the briefing target of Aug. 18, 2022, and the briefing target of Aug. 19, 2022. The briefing message transmitted on Aug. 18, 2022, may display the number of the schedules including the fourth item 414, and the briefing message transmitted on Aug. 19, 2022, may also display the number of the schedules including the fourth item 414.

According to an embodiment, the list 410 of the schedules displayed on the scheduling interface may first display a schedule corresponding to a date on which the scheduling function is called. For example, when the date on which the scheduling function is called is Aug. 18, 2022, the schedules corresponding to Aug. 18, 2022, may be first displayed.

According to an embodiment, the list 410 of the schedules displayed on the scheduling interface may first display a schedule corresponding to a date on which a briefing message is transmitted. For example, when the date on which the briefing message is transmitted is Aug. 18, 2022, and the screen 401 of the scheduling interface is displayed by a call for the scheduling function through the briefing message, the schedule corresponding to Aug. 18, 2022, may be first displayed.

According to an embodiment, the schedules included by the list 410 of the schedules may be arranged in a chronological order of start times or end times. For example, as the screen 401 illustrated in FIG. 4A, the first, second, third, fourth, and fifth items 411, 412, 413, 414, and 415 of the schedules included by the list 410 of the schedules may be arranged in an order from early to late start times of the schedules.

According to an embodiment, the scheduling interface may provide a function of registering a new schedule. When selecting a ‘register a schedule’ button 420, an interface for registering the new schedule may be provided.

According to an embodiment, referring to the screen 401, the first-type records included by the list 410 of the first-type records may be displayed such that each item may be distinguished from another item. For example, by using different bars, icons, fonts, font colors, and other indicators, each of the items included by the list 410 of the first-type records may be displayed such that each item may be distinguished from another item. For example, the same item may be displayed in the same displaying method.

According to an embodiment, the scheduling interface provided to the terminal in response to the scheduling function called by an input of selecting the first interfacing object 321 included by the briefing message illustrated in FIG. 3 may be switched to an interface corresponding to another assistant function by a user input. For example, referring to the screen 401, when an input of selecting a ‘to-do’ tab is received, the scheduling interface may be switched to a to-do management interface, and when an input of selecting a ‘reserved message’ tab, the scheduling interface may be switched to a reserved message management interface. For example, interfaces respectively corresponding to a plurality of assistant functions may be implemented as pages connected to one another and may be switched to a screen (e.g., a screen 501 of FIG. 5A or a screen 601 of FIG. 6A) of another interface corresponding to another assistant function through a page switch input, such as a swipe input received through the screen 401. The to-do management interface (e.g., an interface corresponding to the screen 501 of FIG. 5A) provided by an input of selecting the second interfacing object 322 included by the briefing message illustrated in FIG. 3 and the reserved message management interface (e.g., an interface corresponding to the screen 601 of FIG. 6A) provided by an input of selecting the third interfacing object 323 included by the briefing message illustrated in FIG. 3 may be implemented to be switched to another screen of another interface corresponding to another assistant function through the page switch input in the same method.

For example, a screen 402 of an interface for registering a new schedule illustrated in FIG. 4B may be displayed on the terminal in response to a new schedule registration function called by an input of selecting the ‘register a schedule’ button 420 illustrated in FIG. 4A.

Referring to FIG. 4B, a user may input information (e.g., the name of a schedule and the start/end times of the schedule) on a new schedule through the interface for registering the new schedule. The user may request the generation of a schedule corresponding to information input to a server through an input of selecting a ‘register’ button 430 of the interface for registering a new schedule. The server may generate the requested schedule and register the generated schedule in a schedule database or a calendar under the user account.

FIGS. 5A and 5B are diagrams illustrating a screen of a to-do management interface according to an embodiment.

For example, a screen 501 of the to-do management interface illustrated in FIG. 5A may be displayed on a terminal in response to a to-do management function called by an input of selecting the second interfacing object 322 included by the briefing message illustrated in FIG. 3.

Referring to FIG. 5A, the to-do management interface may include a list 510 of second-type records registered corresponding to a user account logging in to the terminal. For example, the list 510 of the second-type records may include a second-type record identified as a briefing target. The second-type record may be a data unit including information (e.g., a name of a to-do, due date information of the to-do, and/or information on whether the to-do is completed) on the to-do and may be referred to as the “to-do”.

For example, the to-do management interface may display the list 510 of to-dos corresponding to a date on which the to-do management function is called. As another example, when the screen 501 of the to-do management interface is displayed by a call for the to-do management function through the briefing message, the to-do management interface may display the list 510 of the to-dos corresponding to a date on which the briefing message is transmitted.

According to an embodiment, the list 510 of the to-dos may include first, second, and third items 511, 512, and 513 including information on the to-dos. For example, the first item 511 included by the list 510 of the to-dos may include the name (“Solve previous mock tests”) of a to-do, a due date (“Thursday, November 18th”) of the to-do, a repetition period (“every day”) of the to-do, and a check box 511-1 for marking whether the to-do is completed.

According to an embodiment, some information of a to-do may not be input. For example, referring to the second item 512, the repetition period of the to-do may not be input, and referring to the third item 513, the due date of the to-do and the repetition period of the to-do may not be input.

According to an embodiment, the to-do management interface may display a list 520 of completed tasks corresponding to the date on which the to-do management function is called. For example, when an input of checking a to-do as a completed task to a check box (e.g., the check box 511-1) for checking whether the to-do is completed with respect to an item (e.g., the first item 511) included by the list 510 of the to-dos, the item (e.g., the first item 511) may be removed from the list 510 of the to-dos and displayed on the list 520 of the completed tasks.

For example, referring to the screen 501, the list 520 of the completed tasks and the list 510 of the to-dos may be displayed to be distinguished from each other in the to-do management interface. For example, the list 520 of the completed tasks may be distinguished by a displayed position by being displayed at the bottom of the list 510 of the to-dos, and the list 520 and the list 510 may each be displayed in areas that are divided by a square box or the like in the to-do management interface. In addition, the list 520 of the completed tasks and the list 510 of the to-dos may be distinguished by being displayed in different font colors or by icons being added thereto to indicate either one. For example, items included by the list 520 of the completed tasks may have a strikethrough added to text thereof different from items included by the list 510 of the to-dos or may be displayed in different font colors from a font color of the items included by the list 510 of the to-dos. For example, a check box (e.g., the check box 511-1) for displaying whether a to-do included by an item (e.g., the first item 511) included by the list 510 of the to-dos is completed may be displayed (e.g., displayed in a transparent circle) to indicate an incomplete state. A check box for displaying whether a to-do included by an item included in the list 520 of the completed tasks is completed may be displayed (e.g., by a checkmark being added or by a color of the circle being changed) to indicate a completed state.

According to an embodiment, a to-do corresponding to a specific date may be determined based on the due date information of a set to-do, the repetition period, and/or a completion state of the to-do. The to-do corresponding to the specific date may be identified as a briefing target of the date.

For example, a to-do to which a due date is set may be included by to-dos respectively corresponding to the set due date or date(s) before the due date. For example, the first item 511 may be included by to-dos corresponding to November 18th or date(s) before November 18th. The second item 512 may be included by to-dos corresponding to September 10th or date(s) before September 10th.

For example, when a to-do is set to be completed before a due date of the to-do passes, the completed to-do may not be included by to-dos corresponding to date(s) after a time of completion. For example, when the second item 512 is completed on September 3rd before the due date (“Wednesday, September 10th”) passes, the second item 512 may not be included in a to-do corresponding to a date (e.g., September 4th to 10th) after September 3rd.

For example, although a to-do is completed before a due date passes, the to-do to which a repetition is set may be included by a to-do corresponding to a date when a set repetition period arrives. For example, since the repetition period of the first item 511 is “every day,” even though a to-do is checked to be completed on a specific date (e.g., November 10th), the to-do may be included by a to-do corresponding to a next date (e.g., November 11th).

According to an embodiment, the to-do management interface may provide a function of registering a new to-do. When selecting a ‘register a to-do’ button 530, an interface for registering the new to-do may be provided.

According to an embodiment, the first, second, and third items 511, 512, and 513 of the to-dos included by the list 510 of the to-dos or items of completed to-dos included by the list 520 of the completed to-dos may include an interfacing object for a bookmark function. When an input of selecting the interfacing object for the bookmark function is received, a bookmark may be set for an item. For example, the item for which the bookmark is set may be displayed on top of items for which a bookmark is not set on the list 510 or 520 or a list of items for which a bookmark is set and a list of items for which no bookmark is set may be displayed by being distinguished from each other.

For example, a screen 502 of an interface for registering a new to-do illustrated in FIG. 5B may be displayed on the terminal in response to a new to-do registration function called by an input of selecting the ‘register a to-do’ button 530 illustrated in FIG. 5A.

Referring to FIG. 5B, a user may input information (e.g., the name of a to-do, the end date of the to-do, and the number of repetitions) on a new to-do through the interface for registering the new to-do. The user may request a server to generate a to-do item through an input of selecting a ‘register’ button 540 of the interface for registering a new to-do. The server may generate the requested to-do and register the generated to-do in a to-do database under the user account.

FIGS. 6A and 6B are diagrams illustrating a screen of a reserved message management interface according to an embodiment.

For example, a screen 601 of the reserved message management interface illustrated in FIG. 6A may be displayed on a terminal in response to a reserved message management function called by an input of selecting the third interfacing object 323 included by the briefing message illustrated in FIG. 3.

Referring to FIG. 6A, the reserved message management interface may include a list 610 of third-type records registered corresponding to a user account logging in to the terminal. For example, the list 610 of the third-type records may include a third-type record identified as a briefing target. The third-type record may be a data unit including information (e.g., content of a reserved message, a scheduled transmission time of the reserved message, a transmission target of the reserved message, and whether a reminder for the reserved message is set) on the reserved message and may be referred to as the “reserved message”.

For example, the reserved message management interface may display the list 610 of reserved messages corresponding to a date on which the reserved message management function is called. As another example, when the screen 601 of the reserved message interface is displayed by a call for the reserved message management function through the briefing message, the reserved message management interface may display the list 610 of the reserved messages corresponding to a date on which the briefing message is transmitted.

According to an embodiment, the list 610 of the reserved messages may include first and second items 611 and 612 of the reserved messages including the information on the reserved messages. For example, the first item 611 included by the list 610 of the reserved messages may include content 611-1 of a reserved message, the scheduled transmission time (“2:00 PM Thursday, Nov. 18, 2021”) of the reserved message, and the transmission target (“Younghee Min”) of the reserved message. The transmission target may be set to be a user account, like the first item 611, and a chatroom, like the second item 612. For example, when the transmission target is set to be a chatroom, a reserved message may be transmitted to all user accounts participating in the chatroom.

According to an embodiment, a list of reserved messages may further include information on a state (e.g., in queue, transmission completed, and/or transmission failed) by items. For example, a reserved message may be ‘in queue’ before a scheduled transmission time, in a state of ‘transmission completed’ when transmission is completed to a transmissions target when the scheduled transmission time arrives, and in a state of ‘transmission failed’ when transmission is not completed to the transmission target even when the scheduled transmission time arrives.

According to an embodiment, a reserved message corresponding to a specific date may be determined to be a briefing target based on a set scheduled transmission time of the reserved message. That is, the reserved message corresponding to the specific date may be identified as the briefing target of the date.

For example, a reserved message scheduled to be transmitted may be included by the reserved message corresponding to a date to which the set scheduled transmission time belongs. For example, the first item 611 may be included by a reserved message corresponding to Nov. 18, 2021, to which the scheduled transmission time belongs. The second item 612 may be included by a reserved message corresponding to Dec. 3, 2021, to which the scheduled transmission time belongs.

For example, a briefing message transmitted on Nov. 18, 2021, may display the number of reserved messages of which the scheduled transmission time belongs to Nov. 18, 2021. Referring to FIG. 6A, since the number of reserved messages of which the scheduled transmission time belongs to Nov. 18, 2021, is one, that is, the first item 611, the briefing message transmitted on Nov. 18, 2021, may display the number of reserved messages as one.

According to an embodiment, the list 610 of the reserved messages displayed on the reserved message management interface may first display a reserved message corresponding to the date on which the reserved message management function is called. For example, when the date on which the reserved message management function is called is Nov. 18, 2021, the reserved message corresponding to Nov. 18, 2021, may be first displayed.

According to an embodiment, the list 610 of the reserved messages displayed on the reserved message management interface may first display a reserved message corresponding to the date on which the briefing message is transmitted. For example, when the date on which the briefing message is transmitted is Nov. 18, 2021, and the screen 601 of the reserved message management interface is displayed by a call for the reserved message management function through the briefing message, the reserved message corresponding to Nov. 18, 2021, may be first displayed.

According to an embodiment, the reserved messages included by the list 610 of the reserved messages may be arranged in a chronological order of scheduled transmission times. For example, like the screen 601 illustrated in FIG. 6A, the first and second items 611 and 612 of the reserved messages included by the list 610 of the reserved messages may be arranged in an order from early scheduled transmission time to late scheduled transmission time of the reserved messages.

According to an embodiment, the reserved message management interface may provide a function of registering a new reserved message. When selecting a ‘reserve a message’ button 620, an interface for registering the new reserved message may be provided.

For example, a screen 602 of an interface for registering a new reserved message illustrated in FIG. 6B may be displayed on the terminal in response to a new reserved message registration function called by an input of selecting the ‘reserve a message’ button 620 illustrated in FIG. 4A.

Referring to FIG. 6B, a user may input information (e.g., the content of a reserved message, the scheduled transmission date of the reserved message, the transmission target of the reserved message, and whether a reminder for the reserved message is set) on a new reserved message through an interface for registering the new reserved message. The user may request the generation of a reserved message corresponding to information input to a server through an input of selecting a ‘register’ button 630 for the interface for registering a new reserved message. The server may generate the requested reserved message and register the generated reserved message in a reserved message database under an account of the user.

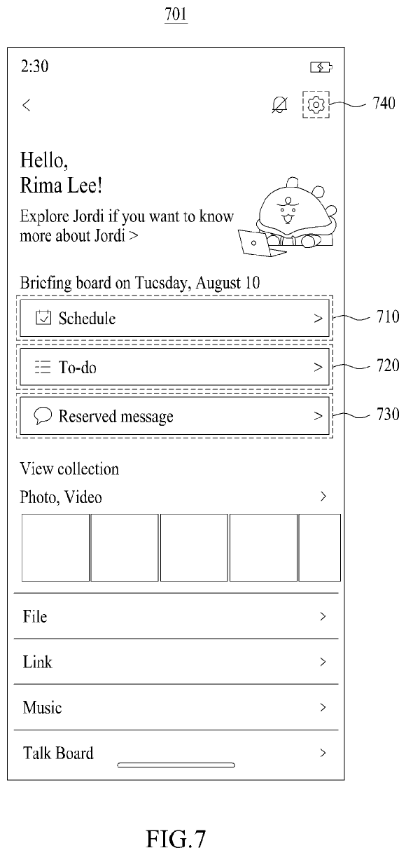

FIG. 7 is a diagram illustrating an example of a screen of an assistant interface provided through an application for a messaging service, according to an embodiment.

According to an embodiment, a comprehensive assistant interface for calling assistant functions may be provided to a terminal, besides respective assistant interfaces corresponding to each of the assistant functions, through a briefing message. For example, a screen 701 of the assistant interface illustrated in FIG. 7 may be displayed on the terminal in response to an input of selecting an interfacing object 324 included by the briefing message illustrated in FIG. 3. For example, the screen 310 may be replaced with the screen 701 in response to an input of selecting the interfacing object 324.

According to an embodiment, an application for a messaging service may provide the terminal with the assistant interface for calling an assistant function through various entry points, besides the briefing message. For example, when a request to execute the assistant function is received through various entry points in the application for the messaging service, the screen 701 of the assistant interface illustrated in FIG. 7 may be displayed on the terminal. For example, the screen 701 of the assistant interface may be called through a side menu provided to a chatroom with yourself or through a chatbot of an official account dedicated to the assistant function.

According to an embodiment, referring to FIG. 7, the comprehensive assistant interface may include ‘schedule,’ ‘to-do,’ and ‘reserved message’ interfacing objects 710, 720, and 730 for respectively calling the assistant functions (e.g., a scheduling function, a to-do management function, and a reserved message function).

According to an embodiment, an input of selecting the ‘schedule’ interfacing object 710 may be an input of calling the scheduling function. The screen 701 may be connected to the screen 401 of the scheduling interface illustrated in FIG. 4A in response to the input of selecting the ‘schedule’ interfacing object 710. For example, the input of selecting the ‘schedule’ interfacing object 710 may be the same as the input of selecting the first interfacing object 321 included by the briefing message illustrated in FIG. 3. For example, the scheduling interface connected by the input of selecting the ‘schedule’ interfacing object 710 may display a list of schedules corresponding to a date of the scheduling function is called.

According to an embodiment, an input of selecting the ‘to-do’ interfacing object 720 may be an input of calling the to-do management function. The screen 701 may be connected to the screen 501 of the to-do management interface illustrated in FIG. 5A in response to the input of selecting the ‘to-do’ interfacing object 720. For example, the input of selecting the ‘to-do’ interfacing object 720 may be the same as the input of selecting the second interfacing object 322 included by the briefing message illustrated in FIG. 3. For example, the to-do management interface connected by the input of selecting the ‘to-do’ interfacing object 720 may display a list of to-dos corresponding to a date of the to-do management function is called.

According to an embodiment, an input of selecting the ‘reserved message’ interfacing object 730 may be an input of calling the reserved message management function. The screen 701 may be connected to the screen 601 of the reserved message management interface illustrated in FIG. 6A in response to the input of selecting the ‘reserved message’ interfacing object 730. For example, the input of selecting the ‘reserved message’ interfacing object 730 may be the same as the input of selecting the third interfacing object 323 included by the briefing message illustrated in FIG. 3. For example, the reserved message management interface connected by the input of selecting the ‘reserved message’ interfacing object 730 may display a list of reserved messages corresponding to a date of the reserved message management function is called.

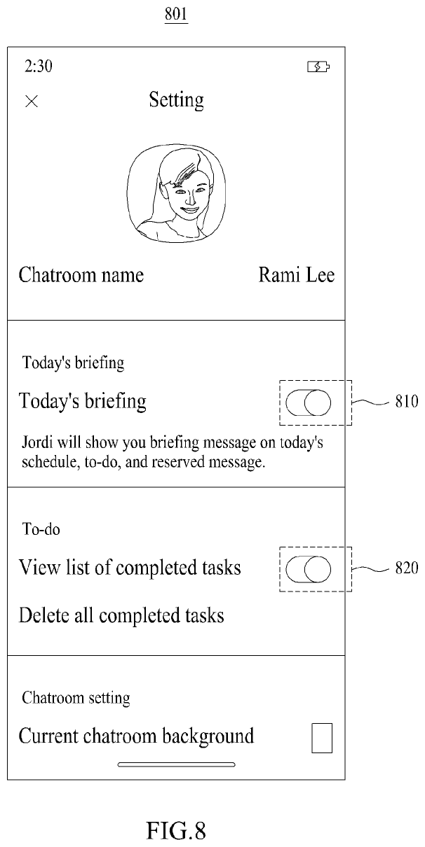

FIG. 8 is a diagram illustrating an example of a screen of an interface for a reception setting for a briefing message, according to an embodiment.

Referring to a screen 801 illustrated in FIG. 8, the interface for the reception setting for the briefing message (hereinafter, a setting interface) may be provided to a terminal through an application for a messaging service. A user may input a reception condition for the briefing message through the setting interface, and the terminal may transmit information on the input reception condition to a server. For example, the setting interface may be called by an input of selecting an interfacing object 740 for a setting request included by the screen 701 of FIG. 7.

For example, the setting interface may include a switch 810 for setting whether to allow the reception of the briefing message. The user may set whether to allow the reception of the briefing message by setting the on/off of the switch 810 through the setting interface.

Although not illustrated in FIG. 8, the setting interface may further include an interfacing object for inputting time information when the reception of the briefing message is allowed. The user may set a time when the reception of the briefing message is allowed or not allowed by inputting a range of a time when the reception of the briefing message is allowed through the setting interface.

According to an embodiment, the setting interface may further include an interfacing object for setting a condition for an assistant interface, besides the condition of the reception of the briefing message. For example, the setting interface may include a switch 820 for setting whether to display a list of completed to-dos on a to-do management interface. The user may set whether to display the list of the completed to-dos on the to-do management interface by setting the on/off of the switch 820 through the setting interface. For example, when the list of the completed to-dos is set to be displayed, as illustrated in the screen 501 of FIG. 5A, the list 520 of the completed to-dos may be displayed through the to-do management interface. In addition, when the list of the completed to-dos is set to be not displayed, the displaying of the list 520 of the completed to-dos may be deactivated. By allowing the user to set the condition for the assistant interface, data requested by the user may be efficiently provided through a limited screen.

According to an embodiment, the server providing an assistant function linked with the application for the messaging service may include a processor, a memory, and a communication module.

According to an embodiment, the processor of the server may perform at least one of the operations of the server described in detail with reference to FIG. 1. For example, the processor of the server may perform at least one of an operation of monitoring the execution of an application of the terminal logging in with a user account subscribing to the messaging service, an operation of identifying briefing targets from records generated based on the execution of the assistant function of the terminal, and an operation of transmitting the briefing message to notify the number of the identified briefing targets to the terminal.

According to an embodiment, the memory of the server may store data necessary for performing the method described in detail with reference to FIG. 1 and/or data generated by performing the method described in detail with reference to FIG. 1. The memory may be a volatile memory or a non-volatile memory.

According to an embodiment, the memory of the server may store a program implementing the method described in detail with reference to FIG. 1. The processor of the server may execute the program stored in the memory and control the server. The code of the program executed by the processor of the server may be stored in the memory.

According to an embodiment, the server may be connected to an external device (e.g., another terminal or a network) through the communication module and may exchange data.

According to an embodiment, the terminal on which the application for the messaging service is installed may include a processor, a memory, and an input/output device.

According to an embodiment, the processor of the terminal may perform at least one of the operations of the terminal described in detail with reference to FIG. 2. For example, the processor of the terminal may perform at least one of an operation of receiving a briefing message from the server providing the assistant function linked with an application, an operation of receiving an input of calling the assistant function through the received briefing message, and an operation of displaying the assistant interface including records registered corresponding to the called assistant function.

According to an embodiment, the memory of the terminal may store data necessary for performing the operations described in detail with reference to FIG. 2 and/or data generated by performing the operations described in detail with reference to FIG. 2. The memory may be a volatile memory or a non-volatile memory.

According to an embodiment, the memory of the terminal may store a program implementing an operating method of the terminal described in detail with reference to FIG. 2. The processor of the terminal may execute the program stored in the memory and control the terminal. The code of the program executed by the processor of the terminal may be stored in the memory.

According to an embodiment, the terminal may be connected to an external device (e.g., a personal computer or the network) through the input/output device and exchange data. For example, the terminal may receive a user's touch input, text input, voice input, and/or other inputs through the input/output device and output a screen of an interface provided through the application.

The examples described herein may be implemented by using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The above-described devices may act as one or more software modules in order to perform the operations of the above-described examples, or vice versa.

As described above, although the examples have been described with reference to the limited drawings, a person skilled in the art may apply various technical modifications and variations based thereon. For example, suitable results may be achieved if the described techniques are performed in a different order and/or if components in a described system, architecture, device, or circuit are combined in a different manner and/or replaced or supplemented by other components or their equivalents.

Accordingly, other implementations are within the scope of the following claims.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An operating method of a server providing an assistant function linked with an application for a messaging service, the operating method comprising:
monitoring an execution of the application of a terminal logging in with a user account subscribing to the messaging service;
determining whether a briefing execution condition for the assistant function is satisfied based on a result of the monitoring;
identifying a briefing target from records generated based on an execution of the assistant function of the terminal based on a result of the determining; and
transmitting a briefing message to notify the identified briefing target to the terminal.

2. The operating method of claim 1, wherein
the determining whether the briefing execution condition is satisfied comprises:
determining whether the execution of the application is a first execution corresponding to the user account within a predetermined period.

3. The operating method of claim 1, wherein
the determining whether the briefing execution condition is satisfied further comprises verifying a reception setting of the user account for the briefing message based on the monitoring result.

4. The operating method of claim 3, wherein
the verifying the reception setting comprises at least one of verifying whether reception of the briefing message is allowed and verifying whether a reception time of the briefing message is limited.

5. The operating method of claim 1, wherein
the identifying the briefing target comprises identifying the briefing target based on time information comprised by the record and a time of the briefing message transmitted.

6. The operating method of claim 1, wherein
the identifying the briefing target further comprises identifying the briefing target by each type of the record determined based on the executed assistant function.

7. The operating method of claim 1, wherein
the assistant function comprises at least one of a scheduling function, a to-do management function, and a reserved message management function, and
the record comprises:
a first-type record on a schedule generated based on an execution of the scheduling function;
a second-type record on a to-do generated based on an execution of the to-do management function; and
a third-type record on a reserved message generated based on an execution of the reserved message management function.

8. The operating method of claim 1, wherein
the briefing message is transmitted through at least one of a first-type chatroom not comprising another user account and a second-type chatroom comprising an official account for the assistant function.

9. The operating method of claim 1, wherein
the transmitting the briefing message to the terminal comprises:
generating information on the number of the identified briefing targets as data in a format to be transmitted as a message; and
requesting a messaging server to transmit the briefing message based on the generated data.

10. An operating method of a terminal on which an application for a messaging service is installed, the operating method comprising:
receiving a briefing message from a server providing an assistant function linked with the application based on an execution of the application;
receiving an input of calling the assistant function through the received briefing message; and
displaying an assistant interface comprising a record registered corresponding to the called assistant function.

11. The operating method of claim 10, wherein
the briefing message comprises information on the number of records corresponding to a specific period among records registered corresponding to the assistant function.

12. The operating method of claim 10, wherein
the receiving the briefing message comprises receiving the briefing message through at least one of a first-type chatroom not comprising another user account and a second-type chatroom comprising an official account for the assistant function.

13. The operating method of claim 10, wherein
the assistant function comprises at least one of a scheduling function, a to-do management function, and a reserved message management function, and
the record comprises:
a first-type record on a schedule generated based on an execution of the scheduling function;
a second-type record on a to-do generated based on an execution of the to-do management function; and
a third-type record on a reserved message generated based on an execution of the reserved message management function.

14. The operating method of claim 10, further comprising setting a reception condition for the briefing message.

15. The operating method of claim 14, wherein
the reception condition comprises whether reception of the briefing message is allowed and time information when the reception of the briefing message is allowed.

16. The operating method of claim 10, further comprising requesting registration of a new record corresponding to the assistant function based on a record input received through the assistant interface.

17. A non-transitory computer-readable storage medium storing instructions that, when executed by a processor, cause the processor to perform an operating method comprising:
monitoring an execution of an application for a messaging service of a terminal logging in with a user account subscribing to the messaging service;
determining whether a briefing execution condition for an assistant function liked with the application for the messaging service is satisfied based on a result of the monitoring;
identifying a briefing target from records generated based on an execution of the assistant function of the terminal based on a result of the determining; and
transmitting a briefing message to notify the identified briefing target to the terminal.

18. A server providing an assistant function linked with an application for a messaging service, the server comprising:
at least one processor configured to:
monitor an execution of the application of a terminal logging in with a user account subscribing to the messaging service,
determine whether a briefing execution condition for the assistant function is satisfied based on a result of the monitoring,
identify a briefing target from records generated based on an execution of the assistant function of the terminal based on a result of the determining, and
transmit a briefing message to notify the identified briefing target to the terminal.

19. The server of claim 18, wherein
the processor is further configured to, when determining whether the briefing execution condition is satisfied,
determine whether the execution of the application is a first execution corresponding to the user account within a predetermined period.

20. A terminal on which an application for a messaging service is installed, the terminal comprising at least one processor configured to:
receive a briefing message from a server providing an assistant function linked with the application based on an execution of the application,
receive an input of calling the assistant function through the received briefing message, and
display an assistant interface comprising a record registered corresponding to the called assistant function.
